(19) United States
(12) Patent Application Publication
(10) Pub. No.: US 2023/0286541 A1
(43) Pub. Date: Sep. 14, 2023

(54) SYSTEM AND METHOD FOR AUTOMATED ROAD EVENT ATTRIBUTION USING REGRESSION TESTING

(71) Applicant: GM Cruise Holdings LLC, San Francisco, CA (US)

(72) Inventors: Matthew Tescher, Alameda, CA (US); Simon Murtha Smith, San Francisco, CA (US)

(73) Assignee: GM Cruise Holdings LLC, San Francisco, CA (US)

(21) Appl. No.: 18/052,070

(22) Filed: Nov. 2, 2022

Related U.S. Application Data
(60) Provisional application No. 63/275,419, filed on Nov. 3, 2021.

(51) Int. Cl. B60W 60/00; G06F 8/71

(52) U.S. Cl. CPC B60W 60/0015; G06F 8/71; B60W 2554/4049

(57) ABSTRACT

A system may attribute an event, which occurred during an operation of an AV, to one or more AV behavior changes through backtesting of the AV software version. The system may identify one or more critical events from events detected by the AV based on classifications of the events. A critical event may be an event that impairs a performance of the AV. The system, after identifying a critical event, may run backtesting of the AV software version. The system may simulate AV operations, which are controlled by the AV software version and one or more historical software versions, in a virtual scene generated based on the critical event. The system may determine whether there is a regression in the AV software version based on AV performances in the simulated AV operations. The system may determine one or more AV behavior changes based on the regression.

### CROSS REFERENCE TO RELATED APPLICATION

This application claims the benefit of U.S. Provisional Patent Application No. 63/275,419, filed Nov. 3, 2021, which is incorporated by reference in its entirety.

### TECHNICAL FIELD OF THE DISCLOSURE

The present disclosure relates generally to autonomous vehicles (AVs) and, more specifically, to event attribution based on regression testing of AV software.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference may be made to the following description, taken in conjunction with the accompanying figures, wherein like reference numerals represent like parts, in which:

FIG. 1 shows an AV environment according to some embodiments of the present disclosure;

FIG. 2 is a block diagram illustrating an online system according to some embodiments of the present disclosure;

FIG. 3 is a block diagram illustrating an event attribution system according to some embodiments of the present disclosure;

FIG. 4 is a block diagram illustrating a sensor suite of an AV according to some embodiments of the present disclosure;

FIG. 5 is a block diagram illustrating an onboard computer of an AV according to some embodiments of the present disclosure;

FIG. 6 illustrates a real-world scene where a critical event occurs according to some embodiments of the present disclosure;

FIG. 7 illustrates a virtual scene generated based on the critical event in FIG. 6 according to some embodiments of the present disclosure; and

FIG. 8 is a flowchart showing a method of event attribution, according to some embodiments of the present disclosure.

### DESCRIPTION OF EXAMPLE EMBODIMENTS OF THE DISCLOSURE

### Overview

Operations and functionality of an AV may be controlled by AV software (also referred to as “software”), such as code executable by an onboard processor in the AV. For instance, an AV may have an onboard computer that includes a memory storing the software and a processor executing the software (sometimes referred to as a software stack). The software may include one or more software components required to run one or more applications, e.g., an application that controls operations of the AV. The software may be updated frequently, e.g., a new version may be released every week, month, or at another frequency. Different versions of AV software (also referred to as “different software versions”) can have different features. Such software updates (also referred to as “AV software update” or “update”) can have regressions and cause changes in AV behaviors, e.g., change in operation safety, change in passenger comfort, or a combination of both. An example regression in a software version may be a software bug where a feature that has worked before stops working. This may happen after a certain event, such as a software upgrade, system patching, etc. Another example of regression is a situation where the current software version still functions correctly but performs more slowly or uses more memory or resources than previous software versions.

A regression can be reflected by events detected by AVs during operations of the AVs. An event is an event that is associated with an AV operation and occurs during operation of the AV. An event may occur along a navigation route of the AV during an operation of the AV but not necessarily occur on a street. For instance, an event may occur in a parking lot. An event that impairs AV performance may be referred to as a concerning event or critical event. Concerning events include safety critical events, comfort critical events, takeover events (e.g., human takeover events), operational malfunctions, or other types of events showing undesired AV performances. For example, an AV may detect a collision or near-miss, indicating unsafe operation. As another example, an AV may detect harsh braking, which can make passengers uncomfortable.

When a new critical event occurs for an AV software release, it can be important to analyze the critical event with the goal of understanding what AV behavior change (or series of changes) contributed to the regression. However, without proper tooling, attributing an AV performance regression can take a long time (e.g., several hours, days, or even longer) of high touch manual analysis. This may include, for example, manually creating simulations that capture the events, backtesting the simulations against historical AV software versions (i.e., AV software versions released in the past), comparing the results of the simulations against each other, and so on. Additionally, the number of events needed to be analyzed and the number of AV software versions can grow over time.

It may be important to run simulations not just on the current version of the AV software, but also on historical versions as well. By running the same or similar simulations on historical versions of the AV software, it makes it possible to understand whether the event was caused by a software regression or whether this event was caused by another reason, e.g., a random exposure to something that the AV had not encountered before the event. For an event that was caused by a software regression, testing simulations on historical software versions can also help to identify the software change that was the root cause of the event. Also, to ensure continual improvement to a particular AV maneuver (e.g., unprotected turns), it may be important to run the simulations against historical AV software releases to ensure that the test of the maneuver is continuous.

Various embodiments of the present disclosure relate to an event attribution system that can automatically attribute events occurred during AV operations to AV behavior changes through backtesting of AV software versions. An AV operation may be controlled by a processor that executes an AV software version generated from an AV software update. The AV software update may be an operation of updating an AV software version, e.g., adding, changing, or removing one or more software components in the AV software version. The AV software version after the update may be referred to as the current software version, and the AV software version before the update may be referred to as a historical software version. Due to the update, the current software version may have a regression from the historical software version, and the regression may cause one or more undesired AV behavior changes, which may cause regression in AV performance.

The event attribution system may be in communication with one or more AVs and receive information of events detected by the AVs during operations of the AVs. The event attribution system may identify a critical event and run simulations to detect regression in the AV software version that controlled the AV operation during which the event occurred. The detected regression may be used to determine one or more AV behavior changes that contributed to the critical event.

In some embodiments, the event attribution system may classify an event that is detected by an AV during an operation of the AV. The event attribution system may determine, based on the classification of the event, whether the event is a critical event. For instance, the event attribution system may determine that the event is critical to the performance of the AV based on the classification of the event. After identifying the critical event, the event attribution system may determine that backtesting of the AV software version that controlled the AV operation (i.e., the current software version) is needed. The event attribution system may generate a virtual scene that captures the critical event. The virtual scene may include a virtual object that represents a real-world object associated with the event, such as a real-world object that is involved in the event. Examples of real-world objects include a person, stop sign, vehicle, tree, traffic light, bird, animal, building, and so on. The virtual scene may also include augmentation objects, i.e., virtual objects representing objects that did not exist in the real-world scene. An augmentation object may be generated based on a real-world object but may have one or more attributes (e.g., orientation, movement, shape, size, color, etc.) that are different from corresponding attributes of the real-world object.

The event attribution system may simulate AV operations in the virtual scene. The AV operations may be controlled with software versions from different AV software updates. For instance, the software versions may include the target software version, which may be released through the latest software update, and one or more historical software versions, which may be released through previous software updates. In some embodiments, the event attribution system may manage simulations through a cloud platform. The event attribution system may evaluate AV performances in the simulated AV operations. For instance, the event attribution system may determine performance scores for the software versions. A performance score for a software version indicates a performance of an AV controlled by the corresponding software version. The event attribution system may compare the performance scores to determine whether there is a regression in the AV software. The event attribution system may present a result of the performance evaluation for display to a user. Additionally or alternatively, the event attribution system may determine one or more AV behavior changes based on the regression and attribute the one or more AV behavior changes to the event.

As will be appreciated by one skilled in the art, aspects of the present disclosure, in particular aspects of event attribution, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors or one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of certain specific embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Example AV Environment

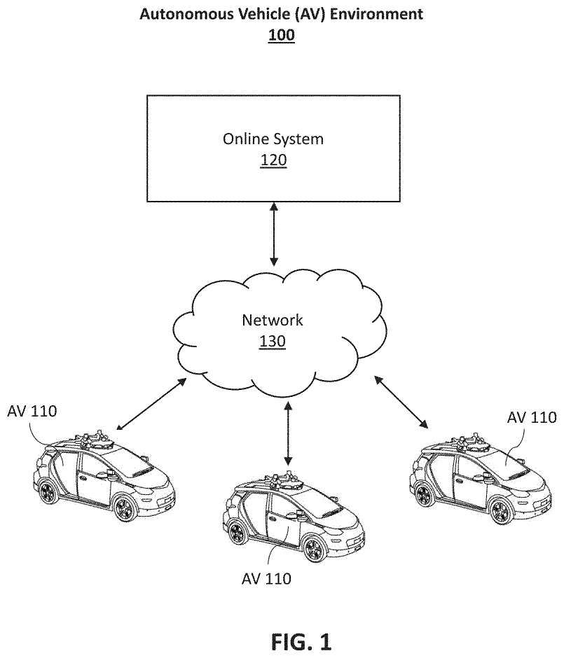

FIG. 1 shows an environment 100 according to some embodiments of the present disclosure. The environment 100 includes AVs 110 and an online system 120 in communication with the AVs 110 through a network 130. In other embodiments, the environment 100 may include fewer, more, or different components. For example, the environment 100 may include one or more devices (e.g., robots) that are not shown in FIG. 1, in addition to or in lieu of the AVs 110. The operation of a robot may be controlled by software that may be provided by the online system 120. A robot may operate in a factory, a warehouse, or a different type of environment. As another example, the environment 100 may include a different number of AVs from FIG. 1. A single AV may be referred to herein as AV 110, and multiple AVs are referred to collectively as AVs 110.

An AV 110 may be a vehicle that may be capable of sensing and navigating its environment with little or no user input. The AV 110 may be a semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV 110 may have attributes of both a semi-autonomous vehicle and a fully autonomous vehicle depending on the state of the vehicle. The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, such as windshield wipers, headlights, turn indicators, air conditioning, and so on.

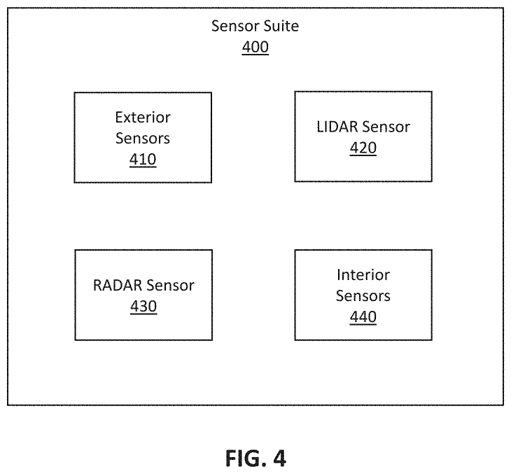

An AV 110 may include an onboard sensor suite that detects objects in the surrounding environment of the AV 110 and generates sensor data describing the objects. Examples of the objects include people, buildings, trees, traffic signs, other vehicles, landmarks, street markers, and so on. The onboard sensor suite may generate sensor data of the objects. The sensor data of the objects may include images, depth information, location information, or other types of sensor data. The onboard sensor suite may include various types of sensors. In some embodiments, the onboard sensor suite may include a computer vision (“CV”) system, localization sensors, and driving sensors. For example, the onboard sensor suite may include photodetectors, interior and exterior cameras, RADAR sensors, sonar sensors, LIDAR sensors, thermal sensors, wheel speed sensors, inertial measurement units (IMUS), accelerometers, microphones, strain gauges, pressure monitors, barometers, thermometers, altimeters, ambient light sensors, and so on. The sensors may be located in various positions in and around the AV 110. For example, the AV 110 may have multiple cameras located at different positions around the exterior and/or interior of the AV 110. More details regarding the sensor suite are described below in connection with FIG. 4.

The AV 110 may also include an onboard computer, such as the onboard computer 300 described below in conjunction with FIG. 300. The onboard computer controls operations and functionality of the AV 110. In some embodiments, the onboard computer may be a general-purpose computer, but may additionally or alternatively be any suitable computing device. The onboard computer can receive software, e.g., from the online system 120, and can run the software (e.g., a version of the software) to control the operations and functionality of the AV 110. The software may include software codes executable by one or more processors in the onboard computer. The code, when executed by the processors, controls the operations and functionality of the AV 110. Different software versions may be released to the AV 110 and other AVs 110 at different times. For instance, a first software version may be released to the AV 110 at a later time, e.g., today, than a second software version that was released to the AV 110 at an earlier time, e.g., a week ago. A newer software version (a software version having a later timestamp) may have more, fewer, or different features from an older software version. The release time of a software version can be the timestamp of the software version.

The onboard computer may be adapted for communication with other components of the AV 110 (e.g., the onboard sensor suite, etc.) and external systems (e.g., the online system 120, etc.). The onboard computer may be connected to the Internet via a wireless connection (e.g., via a cellular data connection). Additionally or alternatively, the onboard computer may be coupled to any number of wireless or wired communication systems.

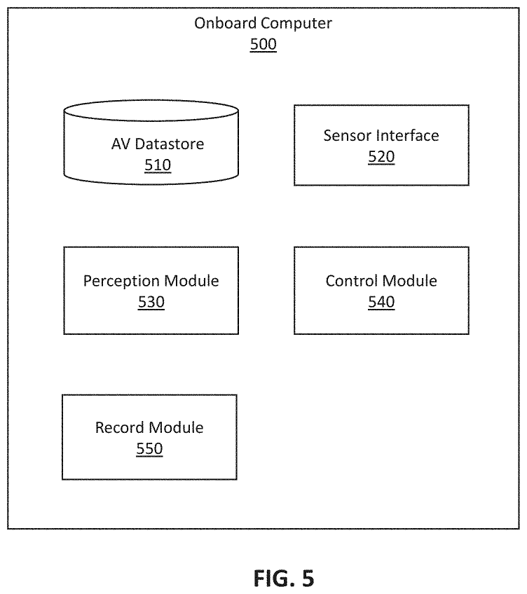

The onboard computer may process sensor data generated by the onboard sensor suite and/or other data (e.g., data received from the online system 120) to determine the state of the AV 110. In some embodiments, the onboard computer implements an autonomous driving system (ADS) for controlling the AV 110 and processing sensor data from the onboard sensor suite and/or other sensors in order to determine the state of the AV 110. For instance, the onboard computer may input the sensor data into a classification model to identify objects detected by the onboard sensor suite. The onboard computer may receive the classification model from a different system, e.g., the online system 120. Based upon the output of the classification model, vehicle state, or programmed instructions, the onboard computer can modify or control the behavior of the AV 110. For instance, the onboard computer can use the output of the classification model to localize or navigate the AV 110. More information on the onboard computer is described below in conjunction with FIG. 5.

An AV 110 may also include a rechargeable battery that powers the AV 110. The battery may be a lithium-ion battery, a lithium polymer battery, a lead-acid battery, a nickel-metal hydride battery, a sodium nickel chloride (“zebra”) battery, a lithium-titanate battery, or another type of rechargeable battery. In some embodiments, the AV 110 may be a hybrid electric vehicle that may also include an internal combustion engine for powering the AV 110, e.g., when the battery has low charge. In some embodiments, the AV 110 may include multiple batteries, e.g., a first battery used to power vehicle propulsion, and a second battery used to power AV hardware (e.g., the onboard sensor suite and the onboard computer 117). The AV 110 may further include components for charging the battery, e.g., a charge port configured to make an electrical connection between the battery and a charging station.

The online system 120 can support the operation of the AVs 110. For example, the online system 120 maintains a version control system that controls updates of AV software versions. An update may be an operation which sends the latest change of an AV software version to a repository of the AV software, making these changes part of the current version of the AV software. The online system 120 may provide software versions to the AVs 110. The online system 120 may update the software versions in the AVs 110, e.g., at a predetermined frequency (e.g., weekly, monthly, etc.) or as needed.

In some embodiments, the online system 120 may use simulation to detect regressions in software versions that have caused critical events during AV operations. an event can be an event detected by an AV 110 during a navigation of the AV 110 in a real-world scene, such as a city, district, road, parking garage, and so on. Some events may be critical to the performance of the AV 110, e.g., critical to the safety of operating the AV 110, passenger comfort, etc. A critical event may be caused by one or more undesired AV behaviors that impairs the AV performance. Examples of critical events include collisions, near-miss, harsh braking, unprotected left turns, unexpected change of speed, risk of collision, and so on. A critical event can indicate a change in a behavior of the AV 110, which can be caused by a regression in the current software version controlling the AV 110 from a previous software version. For instance, the event was not detected by the AV 110 when the AV 110 runs with the previous software version, but because of a regression in the current software version, the performance of the AV 110 may be changed, causing occurrence of the event. The online system 120 may run a simulation based on a critical event to detect regression in the current software version. The regression in the current software version may cause one or more AV behavior changes that further caused the critical event.

In some embodiments, the online system 120 may also manage a service that provides or uses the AVs 110, e.g., a service for providing rides to users with the AVs 110, or a service that delivers items using the AVs (e.g., prepared foods, groceries, packages, etc.). The online system 120 may select an AV from a fleet of AVs 110 to perform a particular service or other task. The online system 120 may instruct the selected AV 110 to autonomously drive to a particular location (e.g., a delivery address). The online system 120 may also manage fleet maintenance tasks, such as charging and servicing of the AVs 110.

In some embodiments, the online system 120 may also provide the AV 110 (and particularly, onboard computer) with system backend functions. The online system 120 may include one or more switches, servers, databases, live advisors, or an automated voice response system (VRS). The online system 120 may include any or all of the aforementioned components, which may be coupled to one another via a wired or wireless local area network (LAN). The online system 120 may receive and transmit data via one or more appropriate devices and network from and to the AV 110, such as by wireless systems, such as a wireless LAN (WLAN) (e.g., an IEEE 802.11 based system), a cellular system (e.g., a wireless system that utilizes one or more features offered by the 3rd Generation Partnership Project (3GPP), including GPRS), and the like. A database at the online system 120 can store account information, such as subscriber authentication information, vehicle identifiers, profile records, behavioral patterns, and other pertinent subscriber information. The online system 120 may also include a database of roads, routes, locations, etc. permitted for use by the AVs 110. The online system 120 may communicate with the AV 110 to provide route guidance in response to a request received from the vehicle.

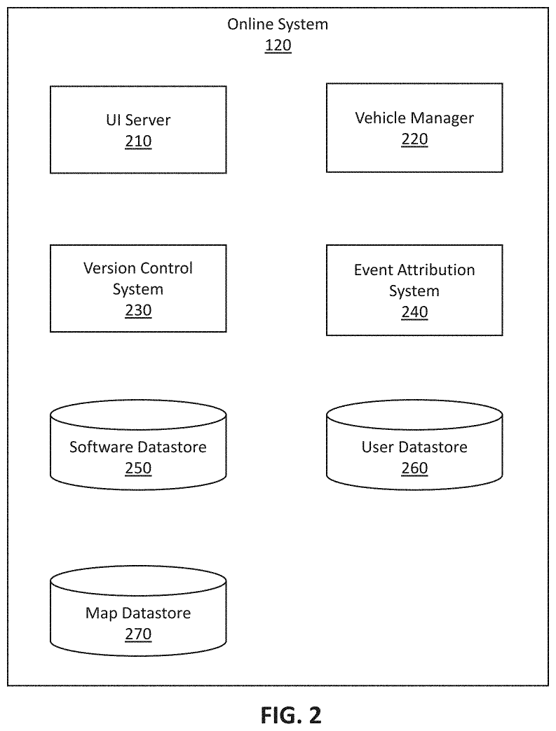

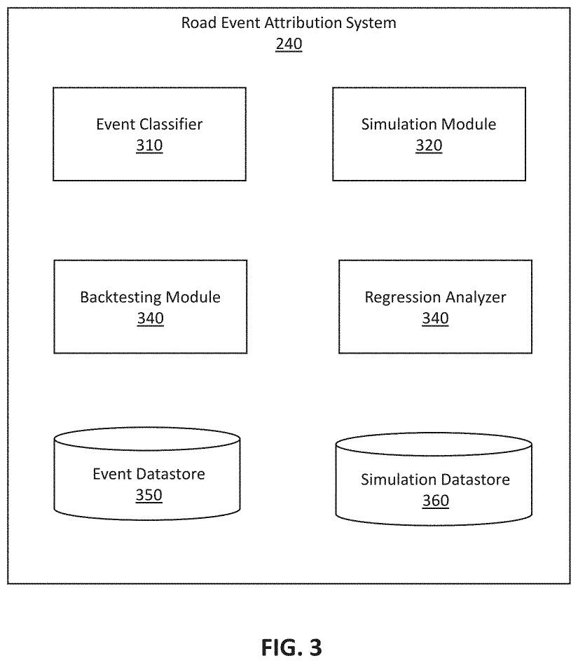

For example, based upon information stored in a mapping system of the online system 120, the online system 120 may determine the conditions of various roads or portions thereof. The AV 110, may, in the course of determining a navigation route, receive instructions from the online system 120 regarding which roads or portions thereof, if any, are appropriate for use under certain circumstances, as described herein. Such instructions may be based in part on information received from the AV 110 or other autonomous vehicles regarding road conditions. Accordingly, the online system 120 may receive information regarding the roads/routes generally in real-time from one or more vehicles. Certain aspects of the online system 120 are provided below in conjunction with FIGS. 2 and 3.

The network 130 can support communications between an AV 110 and the online system 120. The network 130 may comprise any combination of local area and/or wide area networks, using both wired and/or wireless communication systems. In one embodiment, the network 130 may use standard communications technologies and/or protocols. For example, the network 130 may include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

Example Online System

FIG. 2 is a block diagram illustrating the online system 120 according to some embodiments of the present disclosure. The online system 120 may include a UI (user interface) server 210, a vehicle manager 220, a version control system 230, an event attribution system 240, a software datastore 250, a user datastore 260, and a map datastore 270. In alternative configurations, different or additional components may be included in the online system 120. Further, functionality attributed to one component of the online system 120 may be accomplished by a different component included in the online system 120 or a different system, e.g., the onboard computer 500.

The UI server 210 may be configured to communicate with third-party devices that provide a UI to users of the online system 120. For example, the UI server 210 may be a web server that provides a browser-based application to third-party devices. As another example, the UI server 210 may be a mobile app server that interfaces with a mobile app installed on third-party devices. The UI enables the user to request or access services facilitated by the online system 120, such as services partially or wholly performed by AVs. The services may include ride service, delivery service, and so on.

The UI server 210 may provide interfaces to client devices of users, such as headsets, smartphones, tablets, computers, and so on. The UI server 210 may enable a user to submit a request for a service provided or enabled by the online system 120 through a client device. In an example, the UI server 210 may enable a user to submit a ride request that includes an origin (or pickup) location and a destination (or drop-off) location. The ride request may include additional information, such as a number of passengers traveling with the user, and whether or not the user is interested in a shared ride with one or more other passengers not known to the user.

The vehicle manager 220 may manage and communicate with AVs (e.g., AVs 110) associated with the online system 120. The vehicle manager 220 may assign the AVs to various tasks and direct the movements of the AVs in the fleet. In some embodiments, the vehicle manager 220 may select AVs from a fleet to perform various tasks and instructs the AVs to perform the tasks. For example, the vehicle manager 220 receives a ride request from a client device associated with a user of the online system 120. The vehicle manager 220 selects an AV to service the ride request based on the information provided in the ride request, e.g., the origin and destination locations. If multiple AVs in the AV fleet are suitable for servicing the ride request, the vehicle manager 220 may match users for shared rides based on an expected compatibility. For example, the vehicle manager 220 may match users with similar user interests, e.g., as indicated by the user datastore 260. In some embodiments, the vehicle manager 220 may match users for shared rides based on previously-observed compatibility or incompatibility when the users had previously shared a ride.

The vehicle manager 220 or another system may maintain or access data describing each of the AVs in the fleet of AVs, including current location, service status (e.g., whether the AV is available or performing a service; when the AV is expected to become available; whether the AV is schedule for future service), fuel or battery level, etc. The vehicle manager 220 may select AVs for service in a manner that optimizes one or more additional factors, including fleet distribution, fleet utilization, and energy consumption. The vehicle manager 220 may interface with one or more predictive algorithms that project future service requests and/or vehicle use, and select vehicles for services based on the projections. In some embodiments, the vehicle manager 220 may instruct AVs to drive to other locations while not servicing a user, e.g., to improve geographic distribution of the fleet, to anticipate demand at particular locations, etc. The vehicle manager 220 may also instruct AVs to return to an AV facility for fueling, inspection, maintenance, or storage.

The vehicle manager 220 transmits instructions dispatching the selected AVs. In particular, the vehicle manager 220 instructs a selected AV to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle manager 220 may dispatch the same AV to pick up additional users at their pickup locations, e.g., the AV may simultaneously provide rides to three, four, or more users. The vehicle manager 220 further instructs the AV to drive autonomously to the respective destination locations of the users.

The version control system 230 may manage release of AV software versions to AVs. An AV software version includes code that can be executed by the onboard computer (e.g., the onboard computer 500) of an AV to control functionality and operations of the AV. The version control system 230 may send an AV software version to an AV through the network 130 or another data transfer channel. The version control system 230 may provide different AV software versions to different AVs. In some embodiments, the version control system 230 may determine which AV software version is to be sent to an AV based on various factors, e.g., a purpose of operations of the AV, an area in which the AV navigates, one or more hardware parts in the AV, and so on. The purpose of operations of the AV may be providing one or more types of service, testing hardware or software components of the AV, calibrating hardware or software components of the AV, and so on.

The version control system 230 may facilitate updates of AV software versions. A software update may be an operation that releases the latest changes of code so that these changes become part of the latest version of the AV software to be used in an AV. Each software update may produce a new version of the AV software The version control system 230 may track the software updates. For instance, the version control system 230 generates and maintains a timestamp of each software update. The timestamp may indicate a time when the software update was performed by the version control system 230. The version control system 230 may use the timestamp of a software update to identify the version generated from the software update. In some embodiments, the version control system 230 may control timing of software updates. For instance, the version control system 230 may determine a frequency of software updates. The version control system 230 may also determine a time when a version of an AV software is sent to an AV, e.g., a time when the AV is not in operation or service. The version control system 230 may store the current versions as well as one or more historical versions of an AV software in the software datastore 250. Historical versions of the AV software may be used by the event attribution system 240 for regression testing or backtesting.

The event attribution system 240 may run simulations to detect regressions in AV software versions based on identification of critical events that have occurred during AV operations. In an embodiment, the event attribution system 240 may receive an event log from an AV, e.g., from the onboard computer of the AV. The event log may include events detected by the AV during an operation of the AV that is controlled by the current software version. The event attribution system 240 may classify the events. Example classifications of events include safety critical events, comfort critical events, takeover events (e.g., human takeover events), operational malfunctions, and so on. The event attribution system 240 identifies one or more critical events from the event log based on the classifications.

The event attribution system 240 may run a simulation of a critical event for the current software version against previous software versions. In some embodiments, the event attribution system 240 may generate a declarative file for each critical event. The declarative file includes information describing how to generate the simulation (e.g., specifications of a virtual scene for the simulation, specification of virtual objects in the virtual scene, specifications of virtual AVs for the simulation, etc.), what to test in the simulation (e.g., specifications of critical events, specification of AV software versions, etc.), how to run the simulation (e.g., specification of sequence of simulations, specification of duration of time of a simulation, etc.). The event attribution system 240 may convert the declarative file to executable instructions, which can be executed by processors, to run the simulation. In some embodiments, the event attribution system 240 runs the simulation through a cloud platform that manages resources (e.g., processor, memory, storage, etc.) that can be available for running the simulation. The event attribution system 240 may also use the cloud platform to manage AV software updates.

In some embodiments, the event attribution system 240 may generate a test suite for running simulations of critical events. The test suite may include one or more simulation scenarios. A simulation scenario may have a declarative file for an identified event and describes what to test in the simulation and how to analyze the results of the simulation. A declarative file may also include metadata about the simulation scenario, such as name, slug (e.g., clean URL (uniform resource locator)), purpose, creator, or other information of the declarative file. The test suite may convert the declarative file of a simulation scenario into an executable file. The executable file includes code that, when executed by processors, may generate a simulation capturing the corresponding event. In some embodiments, in response to an addition of a new declarative file to the test suite, the test suite may initiate a new simulation based on the new declarative file.

The event attribution system 240 may use data from the simulation to determine performance scores of different software versions and to detect regression in the current software version from one or more historical software versions. For instance, the event attribution system 240 determines whether the difference between the performance scores of two software versions (e.g., a later software version having a later release time and an earlier software version having an earlier release time) is beyond a threshold value. In embodiments where the difference is beyond the threshold value, the event attribution system 240 determines that there is a regression in the later software version from the earlier software version, which causes the occurrence of the event. The event attribution system 240 may further analyze the regression and change the later software version to address the regression.

The software datastore 250 may store software versions released by the version control system 230. The software datastore 250 may also store timestamps of the software versions, e.g., timestamps of software updates from which the software versions are generated or released. The software datastore 250 may further store data related to backtesting of software versions, such as information of critical events, declarative files for simulation, detected regressions in software versions, and so on.

The user datastore 260 stores information associated with users of the online system 120. The user datastore 260 stores information associated with rides requested or taken by the user. For instance, the user datastore 260 may store information of a ride currently being taken by a user, such as an origin location and a destination location for the user's current ride. The user datastore 260 may also store historical ride data for a user, including origin and destination locations, dates, and times of previous rides taken by a user. The user datastore 260 may also store expressions of the user that are associated with a current ride or historical ride. In some cases, the user datastore 260 may further store future ride data, e.g., origin and destination locations, dates, and times of planned rides that a user has scheduled with the ride service provided by the AVs and online system 120. Some or all of the information of a user in the user datastore 260 may be received through the UI server 210, an onboard computer (e.g., the onboard computer 500), a sensor suite (e.g., the sensor suite 400), a third-party system associated with the user and the online system 120, or other systems or devices.

In some embodiments, the user datastore 260 stores data indicating user sentiments towards AV behaviors associated with ride services, such as information indicating whether a user feels comfortable or secured with an AV behavior. The online system 120 may include one or more learning modules (not shown in FIG. 2) to learn user sentiments based on user data associated with AV rides, such as user expressions related to AV rides. The user datastore 260 may also store data indicating user interests associated with rides provided by AVs. The online system 120 may include one or more learning modules (not shown in FIG. 2) to learn user interests based on user data. For example, a learning module may compare locations in the user datastore 260 with map datastore 270 to identify places the user has visited or plans to visit. For example, the learning module may compare an origin or destination address for a user in the user datastore 260 to an entry in the map datastore 270 that describes a building at that address. The map datastore 270 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 260.

In some embodiments, a user is associated with a user profile stored in the user datastore 260. A user profile may include declarative information about the user that was explicitly shared by the user and may also include profile information inferred by the online system 120. In one embodiment, the user profile includes multiple data fields, each describing one or more attributes of the user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, an image of a user may be tagged with information identifying the user displayed in the image.

The map datastore 270 stores a detailed map of environments through which the AVs may travel. The map datastore 270 includes data describing roadways, such as e.g., locations of roadways, connections between roadways, roadway names, speed limits, traffic flow regulations, toll information, etc. The map datastore 270 may further include data describing buildings (e.g., locations of buildings, building geometry, building types), and data describing other objects (e.g., location, geometry, object type) that may be in the environments of AV. The map datastore 270 may also include data describing other features, such as bike lanes, sidewalks, crosswalks, traffic lights, parking lots, signs, billboards, etc.

Some of the map datastore 270 may be gathered by the fleet of AVs. For example, images obtained by the exterior sensors 410 of the AVs may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The online system 120 and/or AVs may have one or more image processing modules to identify features in the captured images or other sensor data. This feature data may be stored in the map datastore 270. In some embodiments, certain feature data (e.g., seasonal data, such as Christmas decorations, or other features that are expected to be temporary) may expire after a certain period of time. In some embodiments, data captured by a second AV may indicate that a previously-observed feature is no longer present (e.g., a blow-up Santa has been removed) and in response, the online system 120 may remove this feature from the map datastore 270.

Example Event Attribution System

FIG. 3 is a block diagram illustrating the event attribution system 240 according to some embodiments of the present disclosure. As described above, the event attribution system 240 runs backtesting of software versions to attribute events to AV behavior changes through simulation. The event attribution system 240 may include an event classifier 310, a simulation module 320, a backtesting module 330, a regression analyzer 340, an event datastore 350, and a simulation datastore 360. Alternative configurations, different or additional components may be included in the event attribution system 240. Further, functionality attributed to one component of the event attribution system 240 may be accomplished by a different component included in the event attribution system 240, the online system 120, or a different system.

The event classifier 310 may classify events, such as events stored in the event datastore 350. The event classifier 310 may retrieve events from the event datastore 350. In some embodiments, the event classifier 310 may retrieve an event log from the event datastore 350 and identify one or more events from the event log. The event log may be received from an AV that detected the one or more events. For instance, an event may be detected by one or more exterior or interior sensors in the sensor suite of the AV during a navigation of the AV in a real-world scene. An event may be an occurrence of an action or a situation in association with an operation of an AV, such as an occurrence that happens to the AV, happens to a passenger of the AV, or happens in an environment surrounding the AV. Examples of event include near-miss, collision, feedback from passenger (e.g., rating, comments, request for assistance, etc.), object (e.g., person, other vehicles, etc.) detected by the AV, operational failure (e.g., failure of a component of the AV), feedback from an object outside the AV (e.g., a pedestrian, car, police, etc.), and so on.

The event classifier 310 may classify at least some of the retrieved events. In some embodiments, the event classifier 310 classifies all the retrieved events. In other embodiments, the event classifier 310 classifies a subset of the retrieved events. In an example, the event classifier 310 may retrieve a large number of events, e.g., many of which may be technical takeover events. The event classifier 310 may determine a sampling rate, which may be a ratio of the number of selected events to the number of identified events. The event classifier 310 may select events from the retrieved events based on the sampling rate. The event classifier 310 may classify the retrieved events.

To classify an event, the event classifier 310 may determine a category of the event. In some embodiments, the event classifier 310 may determine whether the event falls into one of a plurality of predetermined categories. In an example, the predetermined categories may include safety critical events, process safety events, comfort critical events, technical takeover events, and so on. In another example, the predetermined categories may include positive events (i.e., events that positively impact performance of the AV) and negative events (i.e., events that negatively impact performance of the AV). For instance, a near-miss may be classified as a safety critical event or negative event.

In some embodiments, the event classifier 310 may input the event into a model, and the model may output a category of the event. The model may be trained by using machine learning technologies. The event classifier 310 may train the model with a training set. The training set includes training samples, each of which may be an event that occurred during an operation of an AV. A training sample may have one or more ground-truth labels indicating one or more ground-truth categories of the event. The event classifier 310 may extract feature values from the training set, the features being variables deemed potentially relevant to classification of events. The event classifier 310 may also apply dimensionality reduction (e.g., via linear discriminant analysis (LDA), principal component analysis (PCA), or the like) to reduce the amount of data in the feature vectors for ride services to a smaller, more representative set of data. The event classifier 310 may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The event classifier 310 may use classifications of events to identify one or more events for which regression testing on AV software versions is needed. For instance, the event classifier 310 may determine whether an event is critical (e.g., of particular concern) to AV performance based on the category of the event. an event that is critical to AV performance may be an event that impairs AV performance. The performance of the AV may be safety in the operation of the AV, comfort of one or more passengers in the AV, or a combination of both. For example, the event classifier 310 may identify an event classified as a safety critical event as an event for which a regression test is needed. As another example, the event classifier 310 may identify an event classified as a comfort critical event as an event for which a regression test is needed.

The simulation module 320 may generate virtual scenes based on events identified by the event classifier 310. A virtual scene may be a static or animated scene that simulates an event identified by the event classifier 310. A virtual scene may be two-dimensional or three-dimensional. A virtual scene may include one or more virtual objects. A virtual object may be two-dimensional or three-dimensional. A virtual object may be animated. In some embodiments, a virtual object may be a graphical representation of a real-world object, such as a real-world object in a real-world scene where the event occurred. The real-world scene may be a real-world place, e.g., an area where a real AV can navigate. The real-world object may be involved in the event.

In some embodiments, the simulation module 320 may generate the graphical representation of a real-world object based on a perception of the real-world object by one or more AVs. The one or more AVs may include the AV to which the event happened, or another AV that navigated in the real-world scene and captured the event. The simulation module 320 may use sensor data from sensors on the one or more AVs to generate the graphical representation. The simulation module 320 may use AV sensor data to determine attributes (e.g., shape, color, size, features, orientation, movement, etc.) of the real-world object and create the graphical representation based on the attributes. In some embodiments, the simulation module 320 may use one or more images from one or more AV cameras (e.g., exterior camera, interior camera, or both). The simulation module 320 may also use one or more point clouds from one or more LIDAR sensors (e.g., the LIDAR sensor 420). The simulation module 320 may combine sensor data from one or more AV sensors to generate the graphical representation. In an example, the simulation module 320 may combine a point cloud from a LIDAR sensor capturing the real-world object with one or more images of the real-world object that are captured by one or more cameras. The simulation module 320 may use multiple images of the real-world object that are captured from different angles.

In some embodiments, the simulation module 320 may determine that extra sensor data is needed and may send a request for sensor data to the vehicle manager 220. The vehicle manager 220 may dispatch an AV to the real-world scene to capture the requested sensor data or request an AV operating in the real-world scene to capture the requested sensor data. The simulation module 320 may receive the requested sensor data from the vehicle manager 220 or from the AV directly.

The virtual scene may include a graphical representation of at least part of the real-world scene. In an example where the event is a near-miss of a pedestrian coming out from a car parking on a street, the simulation module 320 may generate a virtual scene including virtual objects that represent the pedestrian, car, and street. The relative positions of the virtual pedestrian, virtual car, and virtual street in the virtual scene may match the relative positions of the pedestrian, car, and street in the real-world scene. The virtual scene may be an animated virtual scene that simulates movements of the pedestrian or the car in the real-world scene, such as the walking of the pedestrian or the motion of the car.

In some embodiments, the virtual scene may be an augmented scene that includes one or more virtual objects that do not represent any real-world object in the real-world scene. Such virtual objects are augmentation objects. The simulation module 320 may generate augmentation objects for the purpose of facilitating backtesting of AV software versions by the backtesting module 330. The simulation module 320 may generate an augmentation object based on a real-world object, the graphical representation of which may be present in the virtual scene. In some embodiments, one or more attributes of the augmentation object may be the same as the corresponding attributes of the real-world object. One or more other attributes of the augmentation object may be different from the corresponding attributes of the real-world object. Examples of attributes include shape, size, color, movement, orientation (position, direction, or both), category, and so on. In an embodiment, an augmentation object may be a replica of the graphical representation of the real-world object, but the augmentation object may be placed at different locations in the virtual scene or be added into the virtual scene at different times from the graphical representation of the real-world object. In another embodiment, an augmentation object may have the same category as the real-world object (e.g., both fall into the category of car, construction cone, person, etc.) but have a different size, shape, movement, or orientation from the real-world object. The augmentation objects in the virtual scene can provide more data to test the AV software version and to determine which AV behavior change caused the event.

Taking the near-miss event for example, the simulation module 320 may generate a virtual scene that augments the real-world scene. For instance, the virtual scene may include multiple virtual pedestrians surrounding the virtual car despite that the real-world scene has a single pedestrian surrounding the car. One of the virtual pedestrians may represent the real-world pedestrian and have one or more attributes of the real-world pedestrian. For instance, the virtual pedestrian and the real-world pedestrian may have the same movement, the same size, the same orientation at a particular time, and so on. The other virtual pedestrian(s) (i.e., augmentation pedestrians) may have one or more different attributes from the real-world pedestrian. The augmentation pedestrians may have different movements, different sizes, different orientations, or other different attributes from the real-world pedestrian. In an example, the virtual scene may include a virtual pedestrian that walks out from the car in the same ways as the real-world pedestrian and augmentation pedestrians that walk out from the car at different times or from different angles.

A simulation scene may also include one or more virtual AVs that operate in the virtual scene. In some embodiments, the operations of virtual AVs in the virtual scene may be controlled by different software versions. The software versions may be generated from different software updates. The software versions may be associated with time stamps, such as timestamps of the updates. The software versions may include a target software version and one or more historical software versions. The target software version may correspond to the latest software update. The target software version may be used to control the real-world AV that experienced the event in the real-world scene. A historical software version may correspond to an earlier software update than the target software version and have a timestamp that is earlier than the timestamp of the target software version. The software versions may have a temporal order determined based on their timestamps. A later software version includes one or more changes made to an earlier software version. Simulation scenes generated by the simulation module 320 may be stored in the simulation datastore 360.

The backtesting module 330 may use virtual scenes generated by the simulation module to test AV software versions. In some embodiments, the backtesting module 330 may run simulations that simulate operations of virtual AVs in the virtual scenes. An operation of a virtual AV in the virtual scene may include a navigation of the virtual AV in the virtual scene. In an embodiment, the backtesting module 330 may simulate an operation of a first virtual AV in a virtual scene that is controlled by a target AV software version. The backtesting module 330 may also simulate operations of other virtual AVs in the virtual scene that are controlled by historical software versions. The backtesting module 330 may determine how many historical software versions to test. For instance, the backtesting module 330 may determine to test 2, 3, 4, or even more historical software versions. The backtesting module 330 may run simulations sequentially based on the temporal order of the software versions. For instance, the backtesting module 330 may first run the simulation for the target software version from the latest software update (i.e., the target update), followed by the simulation for the historical software version from the second latest software update (i.e., the first historical update), further followed by the simulation for the historical software version from the third latest software update (i.e., the second historical update), and so on.

In some embodiments, the backtesting module 330 may use a platform that runs in the Cloud to run simulations. The platform may provide services covering at least some functionality of the backtesting module 330. The platform may also provide services covering at least some functionality of the simulation module 320. In an embodiment, the platform may provide an executable simulation generator service, which provides the ability to exchange a simulation scenario with its executable file. The executable file may include a description of how to run the test in the Cloud, e.g., what type of Cloud hardware to run the simulation on (such as a GPU (graphics processing unit) workload, high memory workload, etc.). A comparability hash that can be used to determine if the outputs produced by the simulation can be compared to those of another simulation execution. With this information in hand, systems may reliably run the simulation against historical updates.

The backtesting module 330 may have an interface with the platform. In an embodiment, the backtesting module 330 may send an executable simulation generation request to the platform through the interface. The request can include a simulation scenario, user options, and information about the software version. The interface returns the executable (e.g., backported) version of the simulation scenario, information required to run the simulation in the Cloud, and a comparability hash used to understand if results of a simulation can be compared to those of another simulation run. The simulation runner may also have an orchestrator that orchestrates the deployment and management of executable simulation generator services for AV software versions being tested. In an example, the orchestrator may deploy executable simulation generator service to Cloud engine. Clients can then directly access the executable simulation generator services through the interface. When an executable simulation generation request is complete, the orchestrator provides a way to gracefully decommission the deployed executable simulation generator service.

The regression analyzer 340 analyzes the results of the simulations run by the backtesting module 330. In some embodiments, the regression analyzer 340 receives simulation data from the backtesting module 330. The simulation data may include records of the simulated operations of the virtual AVs. A record of a simulated operation of a virtual AV may be generated by the virtual AV during or after the simulated operation. The regression analyzer 340 may determine performance scores of the virtual AVs based on the simulation data. A performance score may measure a performance of a virtual AV during an operation controlled by a software version and may indicate a performance of a real-world AV in an operation in the real-world when controlled by the software version. The performance score may be also referred to as a performance score of the software version or a performance score of the software update from which the software version was generated.

In some embodiments, the regression analyzer 340 may determine a performance score of a software version by inputting the corresponding simulation data into a model, and the model outputs the performance score. The model may be trained with machine learning techniques. In some embodiments, the regression analyzer 340 may train the model with a training set. The training set includes training samples, each of which may include a record of an operation of an AV (either virtual AV or real-world AV). A training sample may have a ground-truth performance score that measures a known or verified performance of the AV in the operation. The regression analyzer 340 may extract feature values from the training set, the features being variables deemed potentially relevant to determination of performance scores. The regression analyzer 340 may also apply dimensionality reduction (e.g., via LDA, PCA, or the like) to reduce the amount of data in the feature vectors for ride services to a smaller, more representative set of data. The regression analyzer 340 may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The regression analyzer 340 may determine whether there is a regression in the software versions by comparing the performance score of multiple software versions. In an embodiment, the regression analyzer 340 compares the performance score of the target software version with a performance score of a first historical software version and determines whether there is a regression in the target software version from the first historical software version. For instance, the regression analyzer 340 may determine whether a difference between the two performance scores is beyond a threshold value. In response to determining that the difference is beyond a threshold value, the regression analyzer 340 may determine that there is a regression in the target software version from the historical software version. The regression analyzer 340 may also determine whether there is a regression in the target software version from one or more other historical software versions by comparing the performance score of the target software versions with the performance score of each of the one or more other historical software versions. Additionally or alternatively, the regression analyzer 340 may determine whether there is a regression in a first historical software version from a second historical software version by comparing the performance score of the first historical software version with the performance score of each of the second historical software version. The second historical software version may have a later timestamp than the first historical software version.

In some embodiments, the regression analyzer 340 may generate a visual representation of the performance scores. The visual representation may provide the user information to detect regression in AV software versions or regression in AV behaviors. An example of the visual representation may include a series of performance scores, each of which may correspond to a different software version. The performance scores may be arranged in an order that matches the temporal orders of the corresponding software versions. Additionally or alternatively, the visual representation may illustrate, for each respective software version, whether the performance score of the respective software version is higher or lower than another software version immediately preceding the respective software version, which indicates whether there is an improvement or regression in AV performance. An illustration of a lower performance score may indicate that there is a regression in the respective software version from the earlier software version.

The regression analyzer 340 may present the visual representation to one or more users in a UI, e.g., a graphical UI. The visual representation can be used by a system or users to detect regression in AV software versions. In addition to or in lieu of the visual representation of performance scores, the UI may also display information of each detected regression, such as a description of the regression, the type of the regression, the location of the regression in the software version, a recommendation for how to address or fix the regression, and so on. The UI may include interactive elements for a user to interact with performance scores, information of detected regressions, or other information displayed in the UI. An interactive element may be an interactive button, icon, tag, filter, tab, dropdown list, link, text box, number box, and so on.

After determining that there is a regression in a software version, the regression analyzer 340 may determine a change in one or more behaviors of the real-world AV experiencing the event based on the regression. The change in the AV behavior(s) may be caused by the regression in the software version. The regression analyzer 340 may attribute the event at least partially to the change in the AV behavior(s). The change in an AV behavior may be a change from a desirable or neural AV behavior to an undesirable AV behavior. A desirable behavior may be an AV behavior that can enhance AV safety or passenger comfort. An undesirable behavior may be an AV behavior that can undermine AV safety or passenger comfort. A neutral behavior may be an AV behavior that has no influence on AV safety or passenger comfort. The regression analyzer 340 may notify a user or another module of the change in the AV behavior(s). The user or module may make changes to the target software version to address the change in the AV behavior(s). The changes may be made to the target software version in the next update to generate a new software version, which is to be used to control operations of virtual or real-world AVs.

Example Sensor Suite

FIG. 4 is a block diagram illustrating a sensor suite 400 of an AV, according to some embodiments of the present disclosure. The AV may be an embodiment of the AV 110 in FIG. 1. The sensor suite 400 may be an online sensor suite of an AV, e.g., the AV in FIG. 1. The sensor suite 400 includes exterior sensors 410, a LIDAR sensor 420, a RADAR sensor 430, and interior sensors 440. The sensor suite 400 may include any number of the types of sensors shown in FIG. 4, e.g., one or more exterior sensors 410, one or more LIDAR sensors 420, etc. The sensor suite 400 may have more types of sensors than those shown in FIG. 4. In other embodiments, the sensor suite 400 may not include one or more of the sensors shown in FIG. 4.

The exterior sensors 410 detect objects in an environment around the AV. The environment may include a scene in which the AV operates. Example objects include persons, buildings, traffic lights, traffic signs, vehicles, street signs, trees, plants, animals, or other types of objects that may be present in the environment around the AV. In some embodiments, the exterior sensors 410 include exterior cameras having different views, e.g., a front-facing camera, a back-facing camera, and side-facing cameras. One or more exterior sensors 410 may be implemented using a high-resolution imager with a fixed mounting and field of view. One or more exterior sensors 410 may have an adjustable field of views and/or adjustable zooms. In some embodiments, the exterior sensors 410 may operate continually during operation of the AV. In an example embodiment, the exterior sensors 410 capture sensor data (e.g., images, etc.) of a scene in which the AV drives. In other embodiment, the exterior sensors 410 may operate in accordance with an instruction from the onboard computer 500 or an external system, such as the online system 120. Some of all of the exterior sensors 410 may capture sensor data of one or more objects in an environment surrounding the AV based on the instruction.

The LIDAR sensor 420 measures distances to objects in the vicinity of the AV using reflected laser light. The LIDAR sensor 420 may be a scanning LIDAR that provides a point cloud of the region scanned. The LIDAR sensor 420 may have a fixed field of view or a dynamically configurable field of view. The LIDAR sensor 420 may produce a point cloud that describes, among other things, distances to various objects in the environment of the AV.

The RADAR sensor 430 can measure ranges and speeds of objects in the vicinity of the AV using reflected radio waves. The RADAR sensor 430 may be implemented using a scanning RADAR with a fixed field of view or a dynamically configurable field of view. The RADAR sensor 430 may include one or more articulating RADAR sensors, long-range RADAR sensors, short-range RADAR sensors, or some combination thereof.

The interior sensors 440 detect the interior of the AV, such as objects inside the AV. Example objects inside the AV include passengers, client devices of passengers, components of the AV, items delivered by the AV, items facilitating services provided by the AV, and so on. The interior sensors 440 may include multiple interior cameras to capture different views, e.g., to capture views of an interior feature, or portions of an interior feature. The interior sensors 440 may be implemented with a fixed mounting and fixed field of view, or the interior sensors 440 may have adjustable field of views and/or adjustable zooms, e.g., to focus on one or more interior features of the AV. The interior sensors 440 may transmit sensor data to a perception module (such as the perception module 530 described below in conjunction with FIG. 3), which can use the sensor data to classify a feature and/or to determine a status of a feature.

In some embodiments, the interior sensors 440 include one or more input sensors that allow passengers to provide input. For instance, a passenger may use an input sensor to provide information indicating his/her sentiment towards a ride in the AV. The input sensors may include touch screen, microphone, keyboard, mouse, or other types of input devices. In an example, the interior sensors 440 include a touch screen that is controlled by the onboard computer 500. The onboard computer 500 may present questionnaires on the touch screen and receive user answers to the questionnaires through the touch screen. A questionnaire may include one or more questions about a ride the user is taking, have taken, or will take. A user may provide his or her feedback to the ride service by answering questions in a questionnaire through the touch screen.

In some embodiments, some or all of the interior sensors 440 may operate continually during operation of the AV. In other embodiment, some or all of the interior sensors 440 may operate in accordance with an instruction from the onboard computer 500 or an external system, such as the online system 120. The interior sensors 440 may include a camera that can capture images of passengers. The interior sensors 440 may also include a thermal sensor (e.g., a thermocouple, an infrared sensor, etc.) that can capture a temperature (e.g., body temperature) of the passenger. The interior sensors 440 may further include one or more microphones that can capture sound in the AV, such as a conversation made by a passenger.

Example Onboard Computer

FIG. 5 is a block diagram illustrating the onboard computer 500 of an AV according to some embodiments of the present disclosure. The AV may be an embodiment of the AV 110 in FIG. 1. The onboard computer 500 includes an AV datastore 510, a sensor interface 520, a perception module 530, a control module 540, and a record module 550. The AV datastore 510 may be implemented in a memory of the onboard computer 500. The sensor interface 520, perception module 530, control module 540, or record module 550 may be applications run by a processor of the onboard computer 500 that executes codes in an AV software version. In some embodiments, the processor may receive the AV software version from the online system 120 (e.g., from the version control system 230) and execute the codes in the software version to control behaviors of the AV.

In alternative configurations, fewer, different and/or additional components may be included in the onboard computer 500. For example, components and modules for conducting route planning, controlling movements of the AV, and other vehicle functions are not shown in FIG. 5. Further, functionality attributed to one component of the onboard computer 500 may be accomplished by a different component included in the onboard computer 500 or a different system, such as the online system 120.

The AV datastore 510 may store data associated with operations of the AV. The AV datastore 510 may store one or more operation records of the AV. An operation record is a record of an operation of the AV, e.g., an operation for providing a ride service. The operation record may include information describing events experienced by the AV during the operation, information indicating operational behaviors (e.g., perception, prediction, motion, planning, etc.) of the AV during the operation, other information related to the operation of the AV, or some combination thereof. The operations record may also include data used, received, or captured by the AV during the operation, such as map data, instructions from the online system 120, sensor data captured by the AV, and so on. In some embodiments, the AV datastore 510 stores a detailed map that includes a current environment of the AV. The AV datastore 510 may store data in the map datastore 270. In some embodiments, the AV datastore 510 stores a subset of the map datastore 270, e.g., map data for a city or region in which the AV is located.

The sensor interface 520 may interface with the sensors in the sensor suite 140. The sensor interface 520 may request data from the sensor suite 140, e.g., by requesting that a sensor capture data in a particular direction or at a particular time. For example, the sensor interface 520 may instruct the sensor suite 140 to capture sensor data of an environment surrounding the AV. In some embodiments, the request for sensor data may specify which sensor(s) in the sensor suite 140 to provide the sensor data, and the sensor interface 520 may request the sensor(s) to capture data. The request may further provide one or more settings of a sensor, such as orientation, resolution, accuracy, focal length, and so on. The sensor interface 520 can request the sensor to capture data in accordance with the one or more settings.

A request for sensor data by the sensor interface 520 may be a request for real-time sensor data, and the sensor interface 520 can instruct the sensor suite 140 to immediately capture the sensor data and to immediately send the sensor data to the sensor interface 520. The sensor interface 520 is configured to receive data captured by sensors of the sensor suite 140, including data from exterior sensors mounted to the outside of the AV, and data from interior sensors mounted in the passenger compartment of the AV. The sensor interface 520 may have subcomponents for interfacing with individual sensors or groups of sensors of the sensor suite 140, such as a camera interface, a LIDAR interface, a RADAR interface, a microphone interface, etc.

The perception module 530 may identify objects and/or other features captured by the sensors of the AV. For example, the perception module 530 identifies objects in the environment of the AV that are captured by one or more exterior sensors (e.g., the sensors 210-230). The perception module 530 may include one or more classifiers trained using machine learning to identify particular objects. For example, a multi-class classifier may be used to classify each object in the environment of the AV as one of a set of potential objects, e.g., a vehicle, a pedestrian, or a cyclist. As another example, a pedestrian classifier recognizes pedestrians in the environment of the AV, a vehicle classifier recognizes vehicles in the environment of the AV, etc. The perception module 530 may identify travel speeds of identified objects based on data from the RADAR sensor 430, e.g., speeds at which other vehicles, pedestrians, or birds are traveling. As another example, the perception module 53—may identify distances to identified objects based on data (e.g., a captured point cloud) from the LIDAR sensor 420, e.g., a distance to a particular vehicle, building, or other feature identified by the perception module 530. The perception module 530 may also identify other features or characteristics of objects in the environment of the AV based on image data or other sensor data, e.g., colors (e.g., the colors of Christmas lights), sizes (e.g., heights of people or buildings in the environment), makes and models of vehicles, pictures and/or words on billboards, etc.

The perception module 530 may further process data captured by interior sensors (e.g., the interior sensors 440 of FIG. 5) to determine information about and/or behaviors of passengers in the AV. For example, the perception module 530 may perform facial recognition based on sensor data from the interior sensors 440 to determine which user is seated in which position in the AV. As another example, the perception module 530 may process the sensor data to determine passengers' states, such as gestures, activities (e.g., whether passengers are engaged in conversation), moods (whether passengers are bored (e.g., having a blank stare, looking at their phones, etc.)), and so on. The perception module may analyze data from the interior sensors 440, e.g., to determine whether passengers are talking, what passengers are talking about, the mood of the conversation (e.g., cheerful, annoyed, etc.). In some embodiments, the perception module 530 may determine individualized moods, attitudes, or behaviors for the users, e.g., if one user is dominating the conversation while another user is relatively quiet or bored; if one user is cheerful while the other user is getting annoyed; etc. In some embodiments, the perception module 530 may perform voice recognition, e.g., to determine a response to a game prompt spoken by a user.

In some embodiments, the perception module 530 fuses data from one or more interior sensors 440 with data from exterior sensors (e.g., exterior sensors 410) and/or AV datastore 510 to identify environmental objects that one or more users are looking at. The perception module 530 determines, based on an image of a user, a direction in which the user is looking, e.g., a vector extending from the user and out of the AV in a particular direction. The perception module 530 compares this vector to data describing features in the environment of the AV, including the features' relative location to the AV (e.g., based on real-time data from exterior sensors and/or the AV's real-time location) to identify a feature in the environment that the user is looking at.

While a single perception module 530 is shown in FIG. 5, in some embodiments, the onboard computer 500 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 540 may control operations of the AV based on information from the sensor interface 520 or the perception module 530. In some embodiments, the control module 540 controls operation of the AV by using a trained model, such as a trained neural network. The control module 540 may provide input data to the control model, and the control model outputs operation parameters for the AV. The input data may include sensor data from the sensor interface 520 (which may indicate a current state of the AV), objects identified by the perception module 530, or both. The operation parameters are parameters indicating operation to be performed by the AV. The operation of the AV may include perception, prediction, planning, localization, motion, navigation, other types of operation, or some combination thereof.

The control module 540 may provide instructions to various components of the AV based on the output of the control model, and these components of the AV will operate in accordance with the instructions. In an example where the output of the control model indicates that a change of traveling speed of the AV is required given a prediction of traffic condition, the control module 540 may instruct the motor of the AV to change the traveling speed of the AV. In another example where the output of the control model indicates a need to detect characteristics of an object in the environment around the AV (e.g., detect a speed limit), the control module 540 may instruct the sensor suite 140 to capture an image of the speed limit sign with sufficient resolution to read the speed limit and instruct the perception module 530 to identify the speed limit in the image.

The record module 550 generates operation records of the AV and stores the operations records in the AV datastore 510. The record module 550 may generate an operation record in accordance with an instruction from the online system 120, e.g., the vehicle manager 220 or event attribution system 240. The instruction may specify data to be included in the operation record. For instance, an instruction from the event attribution system 240 may request the record module 550 to include an event log into the operation record. The event log includes information describing events experienced by the AV during one or more operations of the AV.

The record module 550 may determine one or more timestamps for an operation record. In an example of an operation record for a ride service, the record module 550 may generate timestamps indicating the time when the ride service starts, the time when the ride service ends, times of specific AV behaviors associated with the ride service, and so on. The record module 550 can transmit operation records to the online system 120, e.g., the event attribution system 240.

Example Real-World Scene

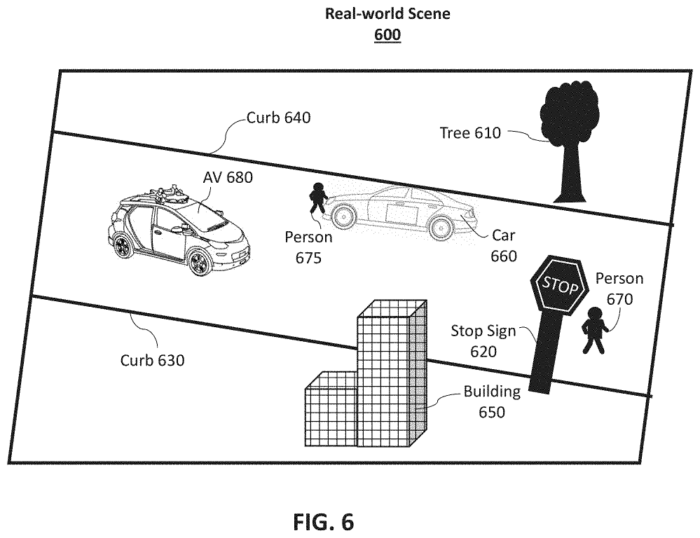

FIG. 6 illustrates a real-world scene 600 where a critical event occurs according to some embodiments of the present disclosure. The real-world scene 600 includes a plurality of real-world objects: a tree 610, a stop-sign 620, a curb 630, another curb 640, a building 650, a car 660, a person 670, another person 675, and an AV 680. In other embodiments, the real-world scene 600 may include different, more, or fewer objects.

The AV 680 operates in the real-world scene 600. For instance, the AV 680 drives in the real-world scene 600. The AV 680 may be an example of the AV 110 in FIG. 1. The operation of the AV 680 may be controlled by an onboard computer (e.g., the onboard computer 500) that executes codes in an AV software version. The AV software version may be generated from a latest AV software update. The AV 680 may include a sensor suite (e.g., the sensor suite 400) that detects at least some of the real-world objects in the real-world scene 600. For instance, the AV 680 may detect the presence of the car 660 and the presence of the person 675 in the vicinity of the AV 680. An onboard computer (e.g., the onboard computer 500) of the AV 680 may determine (either determine for a current time or predict for a future time) an orientation or movement of the car 660 or person 675. For instance, the AV 680 may determine a distance from the person 675 to the AV 680. The AV 680 may also determine a movement of the person 675, e.g., the direction of the movement, the speed of the movement, etc. The onboard computer may control motion of the AV 680 based on the detection of the car 660, person 675, or other objects captured by the AV 680. For instance, the AV 680 would brake and stop upon a detection that the person 675 is getting closer to the AV 680 or that a distance between the person 675 and the AV 680 is below a threshold distance.

The critical event in the embodiment of FIG. 6 includes a near-miss of the person 675, who walks onto the street from the car 660. The near-miss occurs during the operation of the AV 680 in the real-world scene 600 and is captured by the AV 680, e.g., by exterior sensors (such as the exterior sensors 410) of the AV 680. The near-miss may also be associated with a harsh braking of the AV 680. In an example, the AV 680 fails to make a proper detection of the person 675 timely. After perceiving that the person 675 is getting close and determining that the AV 680 needs to stop, the AV 680 does a harsh braking to reduce its speed.

The near-miss or harsh braking of the AV 680 may be classified, e.g., by the event attribution system 240, as a safety critical event as it is critical to the safety of operating the AV 680. The classification of the near-miss or harsh braking may trigger a backtesting of the AV software version through a simulation of the critical event. The backtesting may facilitate the detection of a regression in the latest AV version from one or more previous AV versions and facilitate the analysis of the root cause of the near-miss or harsh braking. For instance, the latest software update may cause an AV behavior change, e.g., a delay in the perception of the person 675. And the near-miss or harsh braking can be attributed to the AV behavior change.

Example Simulated Scene

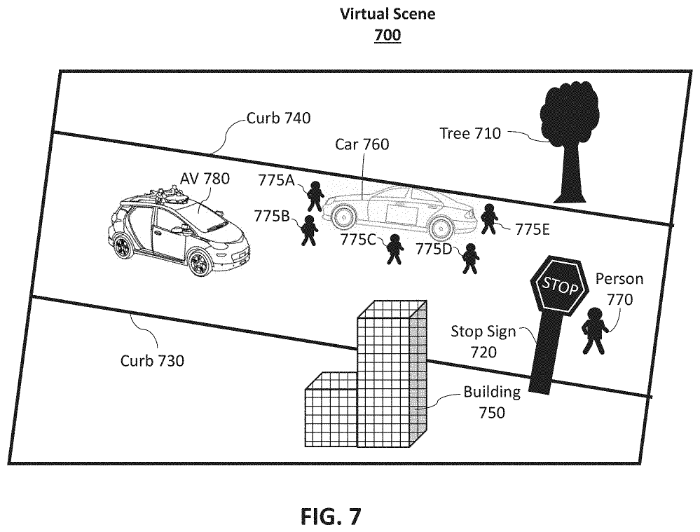

FIG. 7 illustrates a virtual scene 700 generated based on the critical event in FIG. 6 according to some embodiments of the present disclosure. The virtual scene may be a graphical representation of at least part of the real-world scene 600. The virtual scene 700 may be generated by the simulation module 320 and may be used to run backtesting of AV software versions by the backtesting module 330. The virtual scene 700 may be a virtual scene generated based on one or more objects in the real-world scene 600 in FIG. 6. As shown in FIG. 7, the virtual scene 700 includes a virtual tree 710, a virtual stop-sign 720, a virtual curb 730, another virtual curb 740, a virtual building 750, a virtual car 760, a virtual person 770, virtual people 775A-E, and a virtual AV 780. In other embodiments, the virtual scene 700 may include different, more, or fewer objects. For instance, the virtual scene 700 may include no virtual tree 710, virtual stop-sign 720, virtual building 750, or virtual person 770. Also, even though the virtual scene 700 is shown as a two-dimensional static image in FIG. 7, the virtual scene 700 may be three-dimensional, animated, or both. In an embodiment where the virtual scene 700 is animated, the image shown in FIG. 7 may be a frame (or part of the frame) of the virtual scene 700.

Operations of the virtual AV 780 in the virtual scene 700 may be simulated. In some embodiments, a series of AV operations in the virtual scene 700 is simulated. Each of the AV operations may be controlled by the software version generated from a different software update. The series of AV operations may include an AV operation controlled by the software version from the latest update and an AV operation controlled by the software version from the second latest update. The series of AV operations may further include one or more AV operations controlled by software versions from even earlier updates. The AV operations may be run in a sequence, e.g., based on the temporal order of the corresponding software versions. In each AV operation, the virtual AV 780 will encounter the virtual car 760 and the virtual people 775A-E. The behaviors (e.g., perception, prediction, planning, motion, etc.) of the virtual AV 780 may be recorded and used, e.g., by the regression analyzer 340, to detect regression in the latest AV version from one or more historical AV versions.

The virtual scene 700 may simulate the critical event that occurred in the real-world scene 600. The virtual car 760 may be a graphical representation of the car 660 in the real-world scene 600. The virtual car 760 may have the same or similar attributes of the car 660. For example, the virtual car 760 may have the same shape as the car 660. As another example, the orientation of the virtual car 760 in the virtual scene 700 may be the same as the orientation of the car 660 in the real-world scene 600.

The virtual person 775A may be a graphical representation of the person 675 in the real-world scene 600. The virtual person 775A may have one or more attributes that are the same as the person 775. For instance, the virtual person 775A may have the same orientation or movement in the virtual scene 700 as the person 775 having in the real-world scene 600. Also, a relative size of the virtual person 775A to the virtual car 760 or virtual AV 780 may be the same as a relative size of the person 675A to the car 660 or AV 680. The virtual people 775B-E are generated based on the person 675 but have one or more attributes that are different from the person 675 or the virtual person 775A. For example, the virtual people 775B-E may have different orientations or movements from the person 675. As another example, the virtual people 775B-E may appear in the virtual scene 700 at different times from each other or from the virtual person 775A. As yet another example, a relative size of at least one of the virtual people 775B-E to the virtual car 760 or virtual AV 780 may be different from the relative size of the person 675A to the car 660 or AV 680.

The virtual people 775B-E do not represent any real person in the real-world scene 600 but are added to augment the virtual scene 700 to provide more data to analyze the cause of the critical event. For instance, by placing the virtual people 775A-E at different positions, the simulation can test whether the failure of detecting the person 675 timely was related to a position of the person 675. By adding the virtual people 775A-E to the virtual scene 700 at different times, the simulation can test whether the failure of timely detecting the person 675 was related to any timing factors. The virtual people 775B-E are augmentation objects. The addition of the augmentation objects can therefore provide more data to backtest the AV software versions.

For the purpose of simplicity and illustration, FIG. 7 shows four augmentation objects of the same category (i.e., all of the augmentation objects are virtual people). In other embodiments, the virtual scene 700 may include different, fewer, or more augmentation objects and may include augmentation objects of different categories. Also, people are used as an example category in FIG. 7, augmentation objects can be of other categories. In an embodiment, an augmentation object may be a combination of a group of virtual objects, e.g., a virtual object in the group is at least partially occluded by one or more other virtual objects in the group. In other embodiments, the virtual scene 700 may include no augmentation objects.

Example Method of Event Attribution

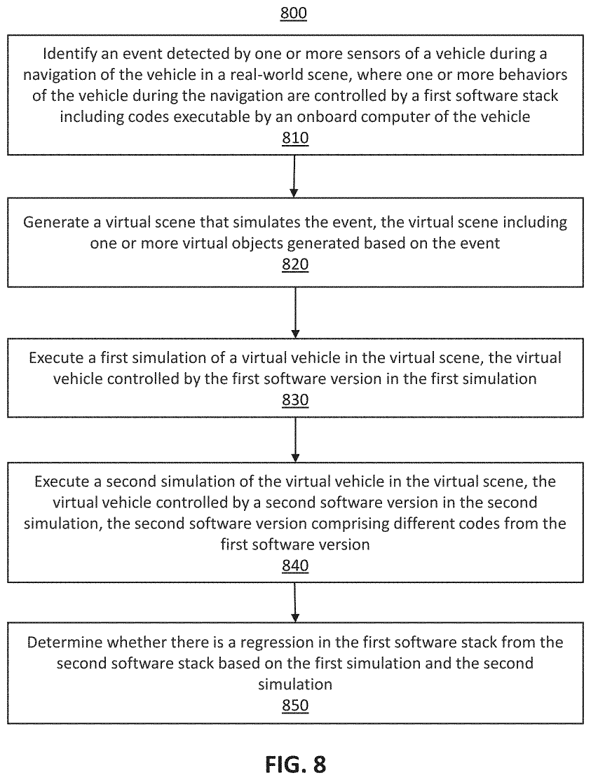

FIG. 8 is a flowchart showing a method 800 of event attribution, according to some embodiments of the present disclosure. The method 800 may be performed by the event attribution system 240. Although the method 800 is described with reference to the flowchart illustrated in FIG. 8, many other methods of event attribution may alternatively be used. For example, the order of execution of the steps in FIG. 8 may be changed. As another example, some of the steps may be changed, eliminated, or combined.

The event attribution system 240 identifies, in 810, an event detected by one or more sensors of a vehicle during a navigation of the vehicle in a real-world scene. One or more behaviors of the vehicle during the navigation are controlled by a first software version comprising codes executable by an onboard computer of the vehicle. In some embodiments, the event attribution system 240 may identify the event based on a classification of the event. The classification may indicate that the event impairs a performance of the vehicle during the navigation in the real-world scene.

The event attribution system 240 generates, in 820, a virtual scene that simulates the event. The virtual scene includes one or more virtual objects generated based on the event. In some embodiments, the event attribution system 240 may generate the one or more virtual objects based on a real-world object involved in the event. The one or more virtual objects comprises a first virtual object having an attribute of the real-world object and a second virtual object having a different attribute from the real-world object.

The event attribution system 240 executes, in 830, a first simulation of a virtual vehicle in the virtual scene. The virtual vehicle is controlled by the first software version in the first simulation.

The event attribution system 240 executes, in 840, a second simulation of the virtual vehicle in the virtual scene. The virtual vehicle is controlled by a second software version in the second simulation. The second software version comprises different codes from the first software version. The second software version comprises different codes from the first software version. The first software version may be generated by making changes to codes in the second software version.

The event attribution system 240 determines, in 850, whether there is a regression in the first software version from the second software version based on the navigation of the first virtual vehicle and the navigation of the second virtual vehicle in the virtual scene. In some embodiments, in response to determining that there is a regression in the first software version from the second software version, the event attribution system 240 may determine a change in the one or more behaviors of the vehicle based on the regression. The event is at least partially attributed to the change in the one or more behaviors of the vehicle.

In some embodiments, the event attribution system 240 may determine a first performance score for the first software version based on a performance of the virtual vehicle in the first simulation. The event attribution system 240 may also determine a second performance score for the second software version based on a performance of the virtual vehicle in the second simulation. The first performance score or second performance score may indicate a level of safety, a level of passenger comfort, or a combination of both.

The event attribution system 240 may compare the first performance score with the second performance score. The event attribution system 240 may determine whether a difference between the first and second performance scores is beyond a threshold value. Subsequent to determining that the difference between the first and second performance scores is beyond the threshold value, the event attribution system 240 may determine that there is a regression in the first software version from the second software version.

In some embodiments, the event attribution system 240 may execute a third simulation of the virtual vehicle in the virtual scene. The virtual vehicle is controlled by a third software version in the third simulation. The event attribution system 240 may determine whether there is the regression in the first software version from the third software version based on a performance of the virtual vehicle in the first simulation and a performance of the virtual vehicle in the third simulation. The second software version may be generated by making changes to codes in the third software version.

### SELECT EXAMPLES

Example 1 provides a computer implemented method, including identifying an event detected by one or more sensors of a vehicle during an operation of the vehicle in a real-world scene, where one or more behaviors of the vehicle during the operation are controlled by a first software version including code executable by an onboard computer of the vehicle; generating a virtual scene that simulates the event, the virtual scene including one or more virtual objects generated based on the event; executing a first simulation of a virtual vehicle in the virtual scene, the virtual vehicle controlled by the first software version in the first simulation; executing a second simulation of the virtual vehicle in the virtual scene, the virtual vehicle controlled by a second software version in the second simulation, the second software version comprising different code from the first software version; and determining whether there is a regression in the first software version from the second software version based on the first simulation and the second simulation.

Example 2 provides the computer implemented method of example 1, where identifying the event includes identifying the event based on a classification of the event, the classification indicating that the event impairs a performance of the vehicle during the operation in the real-world scene.

Example 3 provides the computer implemented method of example 1 or 2, where the first software version is generated by making changes to code in the second software version.

Example 4 provides the computer implemented method of any of the preceding examples, where generating the virtual scene includes generating the one or more virtual objects based on a real-world object involved in the event, where the one or more virtual objects includes a first virtual object having an attribute of the real-world object and a second virtual object having a different attribute from the real-world object.

Example 5 provides the computer implemented method of any of the preceding examples, where determining whether there is the regression in the first software version from the second software version includes determining a first performance score for the first software version based on a performance of the virtual vehicle in the first simulation; determining a second performance score for the second software version based on a performance of the virtual vehicle in the second simulation; and comparing the first performance score with the second performance score.

Example 6 provides the computer implemented method of example 5, where determining whether there is the regression in the first software version from the second software version further includes determining whether a difference between the first and second performance scores is beyond a threshold value; and subsequent to determining that the difference between the first and second performance scores is beyond the threshold value, determining that there is the regression in the first software version from the second software version.

Example 7 provides the computer implemented method of example 5 or 6, where the first performance score or the second performance score indicates a level of safety, a level of passenger comfort, or a combination of both.

Example 8 provides the computer implemented method of any of the preceding examples, further including executing a third simulation of the virtual vehicle in the virtual scene, the virtual vehicle controlled by a third software version in the third simulation; and determining whether there is regression in the first software version from the third software version based on a performance of the virtual vehicle in the first simulation and a performance of the virtual vehicle in the third simulation.

Example 9 provides the computer implemented method of example 8, where the second software version is generated by making changes to code in the third software version.

Example 10 provides the computer implemented method of any of the preceding examples, further including in response to determining that there is a regression in the first software version from the second software version, determining a change in the one or more behaviors of the vehicle based on the regression, where the event is at least partially attributed to the change in the one or more behaviors of the vehicle.

Example 11 provides one or more non-transitory computer-readable media storing instructions executable to perform operations, the operations including identifying an event detected by one or more sensors of a vehicle during an operation of the vehicle in a real-world scene, where one or more behaviors of the vehicle during the operation are controlled by a first software version including code executable by an onboard computer of the vehicle; generating a virtual scene that simulates the event, the virtual scene including one or more virtual objects generated based on the event; executing a first simulation of a virtual vehicle in the virtual scene, the virtual vehicle controlled by the first software version in the first simulation; executing a second simulation of the virtual vehicle in the virtual scene, the virtual vehicle controlled by a second software version in the second simulation, the second software version comprising different code from the first software version; and determining whether there is a regression in the first software version from the second software version based on the first simulation and the second simulation.

Example 12 provides the one or more non-transitory computer-readable media of example 11, where identifying the event includes identifying the event based on a classification of the event, the classification indicating that the event impairs a performance of the vehicle during the operation of the vehicle in the real-world scene.

Example 13 provides the one or more non-transitory computer-readable media of example 11 or 12, where the first software version is generated by making changes to code in the second software version.

Example 14 provides the one or more non-transitory computer-readable media of any one of examples 11-13, where generating the virtual scene includes generating the one or more virtual objects based on a real-world object involved in the event, where the one or more virtual objects includes a first virtual object having an attribute of the real-world object and a second virtual object having a different attribute from the real-world object.

Example 15 provides the one or more non-transitory computer-readable media of any one of examples 11-14, where determining whether there is the regression in the first software version from the second software version includes determining whether there is the regression in the first software version from the second software version includes determining a first performance score for the first software version based on a performance of the virtual vehicle in the first simulation; determining a second performance score for the second software version based on a performance of the virtual vehicle in the second simulation; and comparing the first performance score with the second performance score.

Example 16 provides the one or more non-transitory computer-readable media of example 15, where the first performance score or the second performance score indicates a level of safety, a level of passenger comfort, or a combination of both.

Example 17 provides the one or more non-transitory computer-readable media of any one of examples 11-16, where the operations further include executing a third simulation of the virtual vehicle in the virtual scene, the virtual vehicle controlled by a third software version in the third simulation; and determining whether there is regression in the first software version from the third software version based on a performance of the virtual vehicle in the first simulation and a performance of the virtual vehicle in the third simulation.

Example 18 provides the method of any one of examples 11-17, where the operations further include in response to determining that there is a regression in the first software version from the second software version, determining a change in the one or more behaviors of the vehicle based on the regression, where the event is at least partially attributed to the change in the one or more behaviors of the vehicle.

Example 19 provides a computer-implemented system, including a processor; and one or more non-transitory computer-readable media storing instructions, when executed by the processor, cause the processor to perform operations including: identifying an event detected by one or more sensors of a vehicle during an operation of the vehicle in a real-world scene, where one or more behaviors of the vehicle during the operation are controlled by a first software version including code executable by an onboard computer of the vehicle, generating a virtual scene that simulates the event, the virtual scene including one or more virtual objects generated based on the event, executing a first simulation of a virtual vehicle in the virtual scene, the virtual vehicle controlled by the first software version in the first simulation, executing a second simulation of the virtual vehicle in the virtual scene, the virtual vehicle controlled by a second software version in the second simulation, the second software version comprising different code from the first software version, and determining whether there is a regression in the first software version from the second software version based on the first simulation and the second simulation.

Example 20 provides the computer-implemented system of example 19, where generating the virtual scene includes generating the one or more virtual objects based on a real-world object involved in the event, where the one or more virtual objects includes a first virtual object having an attribute of the real-world object and a second virtual object having a different attribute from the real-world object.

### OTHER IMPLEMENTATION NOTES, VARIATIONS, AND APPLICATIONS

It may be to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It may be also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along with similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it may be intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that may be not otherwise reflected in the appended claims.

What is claimed is:

1. A computer implemented method, comprising:
identifying an event detected by one or more sensors of a vehicle during an operation of the vehicle in a real-world scene, wherein one or more behaviors of the vehicle during the operation are controlled by a first software version comprising code executable by an onboard computer of the vehicle;
generating a virtual scene that simulates the event, the virtual scene including one or more virtual objects generated based on the event;
executing a first simulation of a virtual vehicle in the virtual scene, the virtual vehicle controlled by the first software version in the first simulation;
executing a second simulation of the virtual vehicle in the virtual scene, the virtual vehicle controlled by a second software version in the second simulation, the second software version comprising different code from the first software version; and
determining whether there is a regression in the first software version from the second software version based on the first simulation and the second simulation.

2. The computer implemented method of claim 1, wherein identifying the event comprises:
identifying the event based on a classification of the event, the classification indicating that the event impairs performance of the vehicle during the operation in the real-world scene.

3. The computer implemented method of claim 1, wherein the first software version is generated by making changes to code in the second software version.

4. The computer implemented method of claim 1, wherein generating the virtual scene comprises:
generating the one or more virtual objects based on a real-world object involved in the event, wherein the one or more virtual objects comprises a first virtual object having an attribute of the real-world object and a second virtual object having a different attribute from the real-world object.

5. The computer implemented method of claim 1, wherein determining whether there is the regression in the first software version from the second software version comprises:
determining a first performance score for the first software version based on a performance of the virtual vehicle in the first simulation;
determining a second performance score for the second software version based on a performance of the virtual vehicle in the second simulation; and
comparing the first performance score with the second performance score.

6. The computer implemented method of claim 5, wherein determining whether there is the regression in the first software version from the second software version further comprises:
determining whether a difference between the first and second performance scores is beyond a threshold value; and
subsequent to determining that the difference between the first and second performance scores is beyond the threshold value, determining that there is the regression in the first software version from the second software version.

7. The computer implemented method of claim 5, wherein the first performance score or the second performance score indicates a level of safety, a level of passenger comfort, or a combination of both.

8. The computer implemented method of claim 1, further comprising:
executing a third simulation of the virtual vehicle in the virtual scene, the virtual vehicle controlled by a third software version in the third simulation; and
determining whether there is regression in the first software version from the third software version based on a performance of the virtual vehicle in the first simulation and a performance of the virtual vehicle in the third simulation.

9. The computer implemented method of claim 8, wherein the second software version is generated by making changes to code in the third software version.

10. The computer implemented method of claim 1, further comprising:
in response to determining that there is a regression in the first software version from the second software version, determining a change in the one or more behaviors of the vehicle based on the regression, wherein the event is at least partially attributed to the change in the one or more behaviors of the vehicle.

11. One or more non-transitory computer-readable media storing instructions executable to perform operations, the operations comprising:
identifying an event detected by one or more sensors of a vehicle during an operation of the vehicle in a real-world scene, wherein one or more behaviors of the vehicle during the operation are controlled by a first software version comprising code executable by an onboard computer of the vehicle;
generating a virtual scene that simulates the event, the virtual scene including one or more virtual objects generated based on the event;
executing a first simulation of a virtual vehicle in the virtual scene, the virtual vehicle controlled by the first software version in the first simulation;
executing a second simulation of the virtual vehicle in the virtual scene, the virtual vehicle controlled by a second software version in the second simulation, the second software version comprising different code from the first software version; and
determining whether there is a regression in the first software version from the second software version based on the first simulation and the second simulation.

12. The one or more non-transitory computer-readable media of claim 11, wherein identifying the event comprises:
identifying the event based on a classification of the event, the classification indicating that the event impairs a performance of the vehicle during the operation of the vehicle in the real-world scene.

13. The one or more non-transitory computer-readable media of claim 11, wherein the first software version is generated by making changes to code in the second software version.

14. The one or more non-transitory computer-readable media of claim 11, wherein generating the virtual scene comprises:
generating the one or more virtual objects based on a real-world object involved in the event, wherein the one or more virtual objects comprises a first virtual object having an attribute of the real-world object and a second virtual object having a different attribute from the real-world object.

15. The one or more non-transitory computer-readable media of claim 11, wherein determining whether there is the regression in the first software version from the second software version comprises:
determining a first performance score for the first software version based on a performance of the virtual vehicle in the first simulation;
determining a second performance score for the second software version based on a performance of the virtual vehicle in the second simulation; and
comparing the first performance score with the second performance score.

16. The one or more non-transitory computer-readable media of claim 15, wherein the first performance score or the second performance score indicates a level of safety, a level of passenger comfort, or a combination of both.

17. The one or more non-transitory computer-readable media of claim 11, wherein the operations further comprise:
executing a third simulation of the virtual vehicle in the virtual scene, the virtual vehicle controlled by a third software version in the third simulation; and
determining whether there is regression in the first software version from the third software version based on a performance of the virtual vehicle in the first simulation and a performance of the virtual vehicle in the third simulation.

18. The one or more non-transitory computer-readable media of claim 11, wherein the operations further comprise:
in response to determining that there is a regression in the first software version from the second software version, determining a change in the one or more behaviors of the vehicle based on the regression, wherein the event is at least partially attributed to the change in the one or more behaviors of the vehicle.

19. A computer-implemented system, comprising:
a processor; and
one or more non-transitory computer-readable media storing instructions, when executed by the processor, cause the processor to perform operations comprising:
identifying an event detected by one or more sensors of a vehicle during an operation of the vehicle in a real-world scene, wherein one or more behaviors of the vehicle during the operation are controlled by a first software version comprising code executable by an onboard computer of the vehicle,
generating a virtual scene that simulates the event, the virtual scene including one or more virtual objects generated based on the event,
executing a first simulation of a virtual vehicle in the virtual scene, the virtual vehicle controlled by the first software version in the first simulation,
executing a second simulation of the virtual vehicle in the virtual scene, the virtual vehicle controlled by a second software version in the second simulation, the second software version comprising different code from the first software version, and
determining whether there is a regression in the first software version from the second software version based on the first simulation and the second simulation.

20. The computer-implemented system of claim 19, wherein generating the virtual scene comprises:
generating the one or more virtual objects based on a real-world object involved in the event, wherein the one or more virtual objects comprises a first virtual object having an attribute of the real-world object and a second virtual object having a different attribute from the real-world object.
